(19) United States
(12) Patent Application Publication
(10) Pub. No.: US 2010/0001652 A1
(43) Pub. Date: Jan. 7, 2010

(54) CONTROL DEVICE, SYSTEM AND METHOD FOR PUBLIC ILLUMINATION

(76) Inventor: Jan Willy Damsleth, Torp (NO)

Correspondence Address: WENDEROTH, LIND & PONACK, L.L.P., 1030 15th Street, N.W.,, Suite 400 East, Washington, DC, 20005-1503, US

(21) Appl. No.: 12/310,132

(22) PCT Filed: Sep. 11, 2007
(86) PCT No.: PCT/NO2007/000318

§ 371 Date: Jul. 27, 2009

(30) Foreign Application Priority Data
Sep. 11, 2006 (NO) 2006 4070

(51) Int. Cl. H05B 37/02

(52) U.S. Cl. 315/149; 315/291; 315/294

(57) ABSTRACT

A control unit for an illumination system, the system itself and the involved method to operate the system is presented. The control unit is operatively connected a light source illuminating substantially one cell of an area comprising at least two cells. The unit comprises means to monitor the cell for effects of interest. The unit comprises means to coordinate illumination measures with at least one corresponding control unit in at least one proximate cell by communicating with this corresponding control unit, preferably using a wireless communication method. The illumination measures can comprise adjusting light characteristics variably, setting the light source in a stand-by mode and switching off the light source.

### TECHNICAL FIELD

The present invention relates to the field of control systems. More specifically, it relates to a system of communicative electronic controllers arranged to organize illumination of a cellular area.

### BACKGROUND AND PRIOR ART

Historically illumination of public areas like streets, parks, industrial facilities and similar are done by a number of light sources being switched on when darkness makes illumination necessary. Each light source illuminates a part of the area, hereinafter called a cell, and adjacent cells typically overlap each other. The switching is done by using some light sensor, timer or other means and applies typically for a group of light sources. Also light intensity is adjustable in today's systems to save energy and increase the lifetime of the equipment, however the dimming—variably adjusting the intensity of illumination—is then done for substantially all the light sources of the system. For minor areas also equipment which senses movement of objects with a temperature radiation different from ambient temperature (motion sensors) is used to switch the illumination on only when there seems to be a need for the light. In this case dimming is generally not in use.

Prior documents describing the state of the art comprise U.S. Pat. No. 3,893,000. The document discloses a highway lighting system where a group of light is switched on by a passing vehicle and remaining on for a predetermined time. A further document is the UK patent application 2 303 906 A describing a system for lighting mounted on the supports beside the road and activated by sensors. A report “European Road Lighting Technologies”, Dale Wilken et al, issued by the US Department of Transportation (September 2001) reports about European road lighting standards.

There is however still a need to improve illumination control to much a greater extend and thus to improve energy savings and safety.

### SUMMARY

The present invention discloses a control unit for an illumination system, the system itself and the involved method to operate the system. The objective of the invention is to achieve an energy-efficient illumination and a safe environment. The illumination is for an area, which is formed by at least two cells. The control unit is operatively connected a light source illuminating substantially one cell. The control unit comprises means to monitor the cell for subjects of interest. The unit comprises means to coordinate illumination measures with at least one corresponding control unit in at least one proximate cell by communicating with this corresponding control unit. In a preferred embodiment, communication between said control units is based on a wireless communication method. The illumination measures can comprise adjusting light characteristics variably, setting the light source in a stand-by mode and switching off the light source, where the light characteristics comprise at least one of light intensity and light color. The control unit can monitor its cell by at least one of IR-detectors, electronic cameras with image processing, magnetic sensors, radar equipment, ambient light measuring means, and laser equipment. The subject of interest is in a one embodiment at least one of an object and a person residing inside said cell, moving within said cell, leaving said cell and entering said cell. Said light source may be a single illumination device or a group of illumination devices to be controlled as a single light source. The coordination of illumination measures with the at least one proximate control unit comprises changing illumination in proximate cells to correspond to moving speed and/or a moving direction of said subjects. Another aspect of the present invention is a corresponding system to be used in areas like streets, motorways, parking areas, parks, industrial facilities, public facilities. The coordination of illumination measures comprise incrementally adjusting illumination in a field of view of persons to avoid blinding and/or adjusting illumination changes in proximate cells to correspond the moving speed and/or moving direction of the subjects, which may comprise vehicles and animals. The invention comprises also the aspect of a method to illuminate an area, formed by at least two cells. The method comprises the following steps: monitoring the cell for a subject of interest, sending data about the subject of interest to at least one proximate cell, receiving data from at least one proximate cell, adjusting illumination according to the subject of interest, and/or the data received from one or more proximate cells.

For further details and aspects of the invention, reference is made to the attached claim set.

### BRIEF DESCRIPTION OF THE DRAWINGS

Below the present invention will be described with reference to the attached drawings where

FIG. 1 shows a block schematic of a controller;

FIG. 2 shows a typical application of a street lighting system

### DETAILED DESCRIPTION OF PREFERRED EMBODIMENTS

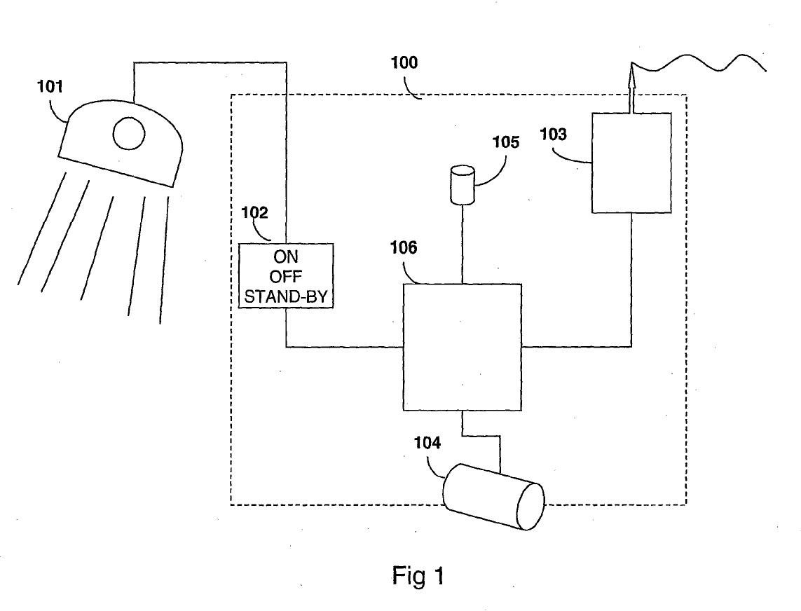

FIG. 1 shows a block diagram of an electronic controller 100 with a central electronic unit 106 to be connected to a light armature 101. The controller has typically the following features:

Switching the light off completely (OFF) 102;

Keeping the light in a stand-by mode (STAND-BY) for fast response in case illumination is needed immediately 102;

Adjusting the light output variably from minimum to maximum (ON) 102;

Communicating with corresponding controllers attached to proximate light armatures 103;

Monitoring a cell—typically identical with the cell to be illuminated by the controlled light—for events of interest, f inst people residing in the cell, people or animals or objects moving around inside the cell or entering or leaving the cell, for instance with a camera 104;

Sensing ambient light conditions 105;

Deciding own illumination activity on the background of (i) information from own sensors and (ii) communicated information from controllers on proximate light armatures.

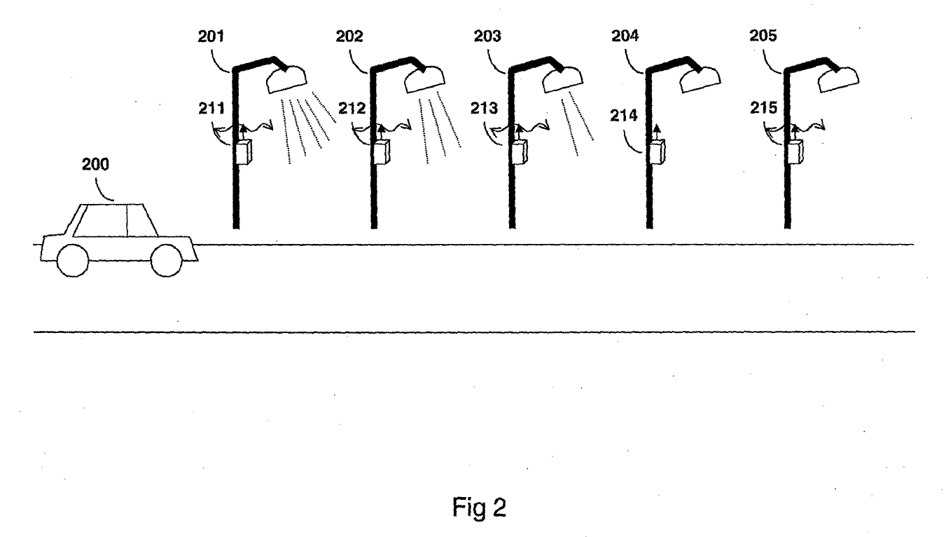

FIG. 2 illustrates a typical system of 5 (as an example) light armatures 201-205 spaced along a street for street illumination of 5 ‘cells’. Cells are over-lapping as is normally the case in the field of illumination. Each light is operatively controlled by an electronic controller 211-215 mounted to the armature.

The following is one possible embodiment of a system function: all lights, assumed being of a type that needs some time-consuming pre-heating, are assumed being in STAND-BY mode since no object has been detected in any of the monitored cells recently, and there is too little ambient light available—it is night—such that the controllers expect the need for illumination.

A vehicle 200 is approaching from left, and this event—including the direction and the velocity of the approach—is monitored by controller 211. Since controller 211 has not received any communication from a left-hand light armature controller, it increases illumination to a value which gives illumination, but without blinding the driver of the vehicle. Additionally the controller communicates the event and parameters like velocity and direction to the neighbor controller 212 where the vehicle will arrive later. Controller 212 then already increases illumination from STAND-BY to a level making the vehicle driver being more accustomed to the light, making it possible to increase illumination further than controller 211 without blinding the driver. And further, controller 212 propagates information about the approaching vehicle event to the next controller 213 which in turn can prepare for the approach of the vehicle.

In another embodiment of the invention—an illumination system along a street with vehicles only coming in at one of the ends—the light sources 205 far away from that end of the street, could be even in OFF mode at night, since they might be able to run the preheating procedure in due time before a vehicle arrives. This opens up for more energy saving and increased lifetime for the lighting equipment.

As soon as no relevant object is sensed inside the cell of the controller and communication with proximate controllers indicates that no object is approaching from outside its own cell, the controller reduces illumination to a minimum (OFF or STAND-BY depending on the conditions described above).

Sensing direction and velocity of objects can be done by image processing if the sensing equipment of the controller comprises an electronic camera and sufficient computing power for image processing or by further communication between two or more controllers which monitor overlapping cells. Also conventional means such as radar, laser or electromagnetic sensor build into the lane can be used.

An illumination system disposed along a street typically allows a structured communication net. In theory each controller communicates only with its two adjacent controllers (‘neighbours’) which makes use of the communicated information and additionally—if necessary—passes the information changed or unchanged through to the next controller. However, in situations where less structured areas have to be illuminated, other and possibly not foreseeable communication paths might be necessary. Therefore the controllers generally can communicate with any other controller within the system as far as the communication means (cabling, range of radio equipment) technically permits the communication. This option is also valuable to support fail-safe operation in cases where some light sources 204, (no light) or controllers 214, (no radio signal) are out of order and can not participate in the communication.

In a further embodiment of the invention special care can be taken of objects entering the system at unexpected places or otherwise behaving unexpectedly; for instance bigger animals entering the street, cars driving in illegal directions, halting at unexpected places (because of flat tire, engine breakdown, . . . ) and similar events. In this case the controller can start special illumination and/or communication programs which may call attention to the event to increase safety in the area.

1. Control unit being operatively connected to control a light source in an illumination system for an area, said area formed by at least two cells, said control unit comprising means to monitor said cell for subjects of interest, characterized by comprising means to coordinate illumination measures with at least one corresponding control unit in at least one proximate cell by two-way communication with said corresponding control unit.

2. Control unit according to claim 1, characterized in that communication between said control units is based on a wireless communication method.

3. Control unit according to claim 1, characterized in that said illumination measures comprise means to variably adjust light characteristics;
means to set said light source in a stand-by mode;
means to switch off said light source.

4. Control unit according to claim 3, characterized in that said light characteristics comprise at least one of
light intensity, and
light color.

5. Control unit according to claim 1, characterized in that said means to monitor said cell comprise at least one of
IR detectors,
electronic cameras with image processing,
magnetic sensors,
radar equipment,
ambient light measurement means, and
laser equipment.

6. Control unit according to claim 1, characterized in that said subject of interest is at least one of an object and a person which are
residing inside said cell
moving within said cell;
leaving said cell; and
entering said cell.

7. Control unit according to claim 1, characterized in that said light source comprises
a single illumination device
a group of illumination devices to be controlled as a single light source.

8. Control unit according to claim 1, characterized in that said coordination of illumination measures with said at least one proximate control unit comprises changing illumination in proximate cells to correspond to at least one of a moving speed and a moving direction of said subjects.

9. System for controlling illumination of an area, said area being formed by at least two cells having a light source in each cell to illuminate said cell and a control unit operatively connected to each light source characterized by
said control unit being arranged to monitor said cell for subjects of interest, two-way communication between said control units,
coordination of illumination measures between proximate control units/cells to achieve an energy-efficient illumination and a safe environment.

10. System according to claim 9, characterized in that said area comprises streets, motorways, parking areas, parks, industrial facilities, public facilities.

11. System according to claim 9, characterized in that said subject of interest is at least one of an object and a person which is
residing inside said cell;
moving within said cell;
leaving said cell; and
entering said cell.

12. System according to claim 9, characterized by said coordination of illumination measures comprise at least one of
incrementally adjusted illumination in proximate cells in a field of view of said person to avoid blinding,
dynamically adjusted illumination in proximate cells to correspond to at least one of a moving speed and a moving direction of said subjects.

13. System according to claim 11, characterized in that said objects comprise vehicles and animals.

14. System according to claim 9, characterized in that said light source comprises
a single illumination device
a group of illumination devices to be controlled as a single light source.

15. Method to illuminate an area, said area formed by at least two cells, each cell being equipped with a light source and a control unit, characterized by the following steps:
monitoring said cell for subjects of interest,
sensing said subjects of interest;
sending data about said subjects of interest to at least one corresponding control unit in at least one proximate cell,
receiving data from at least one corresponding control unit,
adjusting illumination according to at least one of
(i) said subject of interest, and
(ii) said data received from at least one proximate cell.

16. Method according to claim 15, characterized in that said sensing of said subjects of interest determines if said subject is
residing inside said cell;
moving within said cell;
leaving said cell; and
entering said cell.

17. Method according to claim 16, characterized by said adjusting of illumination comprises:
incrementally changing illumination intensity in proximate cells in a field of view of said person to avoid blinding,
adjusting illumination changes in proximate cells to correspond to at least one of a moving speed and a moving direction of said subjects.

18. Control unit according to claim 6, characterized in that said coordination of illumination measures with said at least one proximate control unit comprises changing illumination in proximate cells to correspond to at least one of a moving speed and a moving direction of said subjects.

19. System according to claim 11, characterized by said coordination of illumination measures comprise at least one of
incrementally adjusted illumination in proximate cells in a field of view of said person to avoid blinding,
dynamically adjusted illumination in proximate cells to correspond to at least one of a moving speed and a moving direction of said subjects.
